(19) United States
(12) Patent Application Publication
(10) Pub. No.: US 2021/0158402 A1
(43) Pub. Date: May 27, 2021

(54) METHOD AND SYSTEM FOR ENABLING TRANSACTIONS IN A GOODS TRANSACTION PLATFORM

(71) Applicants: Fabio Gozzi, Sao Paulo (BR); Jose Gozzi, Sao Paulo (BR)

(72) Inventors: Fabio Gozzi, Sao Paulo (BR); Jose Gozzi, Sao Paulo (BR)

(21) Appl. No.: 16/953,019

(22) Filed: Nov. 19, 2020

(30) Foreign Application Priority Data
Nov. 22, 2019 (BR) 1020190245891

(51) Int. Cl. G06Q 30/02; G06Q 20/12; G06Q 50/16; G06Q 50/00; G06K 7/14; G06F 16/93; G09F 9/30

(52) U.S. Cl. CPC G06Q 30/0273; G06Q 30/0201; G06Q 20/1235; G06Q 30/0276; G09F 9/30; G06Q 50/01; G06K 7/1417; G06F 16/93; G06Q 50/16

(57) ABSTRACT

A method and system for enabling transactions on a goods transaction platform which allows a selective communication between at least one ordinary user (10), at least one supplier (20), at least one premium supplier (25), at least one agent (30), at least one external agent (35), at least one launching agent (A) and at least one additional agent (X), the digital platform comprising at least a plurality of databases (100) that may be selectively accessed by each respective user, the plurality of databases (100) comprising at least one free advertising database (D2), a premium advertising database (D2p), a request database (D3), a client intermediate database (I1), an object intermediate database (I2) and a new objects database (D4), wherein the transaction is enabled when at least one data from each of the compared databases is compatible, wherein the transaction is carried out between users relative to compatible data.

### CROSS REFERENCE TO RELATED APPLICATION

This application claims foreign priority under 35 USC § 119 from Brazilian Patent Application No. BR1020190245891 filed Nov. 22, 2019, and the entire disclosure of said prior application is hereby expressly incorporated by reference into the present specification.

### FIELD

The present invention relates to a method and a system for enabling transactions on a goods transaction platform, in which the goods are preferably of a real estate nature and the users are at least one from an ordinary user, a supplier, a premium supplier, an agent, an external agent, a launching agent and an additional agent.

### BACKGROUND

Nowadays, digital platforms for buying and selling products are known to be widely used in several fields, including the real estate one, particularly for buying and selling or leasing properties.

In this sense, it is currently common for such platforms to be configured to merely allow a potential buyer and a potential seller to contact each other.

More specifically, these platforms are set to perform a simple task of making the contact between interested parties in a given transaction easier (buying and selling; leasing). Some of these platforms are also set to generate sale signs for these properties.

These very simple technologies try to optimize the process of buying and selling products, but they do not meet all of the users' needs as they have, for example, a single database of items to be sold and thus they do not allow several interested parties (buyers, sellers, brokers, etc.) to interact properly on a single platform, thus failing in several aspects as will be better described below.

For example, Brazilian patent application no. BR102013002393 discloses a solution in which a platform user obtains information on a property, in particular, images of it. Thus, this solution is only intended to generate a sign with a barcode sign referring to the item being sold and having images of it.

In turn, United States Patent of Invention No. U.S. Pat. No. 8,046,265B2 discloses a method to facilitate a transaction between a seller and a buyer, in which sale offers and buying offers are compared, so that the parties can contact each other if the offers are satisfyingly.

United States Patent of Invention No. U.S. Pat. No. 5,664,115A describes a system that is configured to assess whether a potential buyer meets a minimum criterion to make the purchase and to automatically “match” property sellers and potential buyers if such a condition is satisfied.

Although these solutions merely describe the contact between parties interested in a transaction of buying and selling goods, such solutions do not comprise a configuration involving a plurality of databases which are selectively accessed by users and do not allow several parties interested in such a transaction to be able to interact with each other through a single platform.

Furthermore, these solutions do not disclose specificities (particularities) of the databases that can be accessed and how such access takes place for each user.

Without these specificities, these solutions are obsolete, being configured only to allow contact between a buyer and a seller, without selectively enabling specific conditions in view of the particularities and needs of each party involved.

That is, the state of the art only describes a means of contact between a potential buyer and a potential seller, without addressing all the needs of those involved in this type of transaction.

Therefore, the state of the art provides no solution intended to selectively allow access to different purchase databases, so that these databases are only accessed if specific conditions are met, such databases being composed of different types of information selectively accessible by each type of user.

### OBJECTS OF THE INVENTION

One object of the present invention is to provide a method and a system configured for synchronizing users on a goods transaction platform.

One object of the present invention is to provide a method and a system configured to allow each user to selectively access at least one database of the platform.

One object of the present invention is to provide a method and a system configured to have databases selectively accessible by each platform user.

### BRIEF DESCRIPTION OF THE INVENTION

The objectives of the present invention are achieved by a method for enabling transactions on a digital platform configured to allow selective communication between at least one ordinary user, at least one supplier, at least one premium supplier, at least one agent, at least one external agent, at least one launching agent and at least one additional agent, the digital platform comprising at least a plurality of databases that can be selectively accessed by each respective user, the plurality of databases comprising at least one free advertising database, a premium advertising database, a request database, an client intermediate database, an object intermediate database and a new objects database.

The objectives of the present invention are achieved by a system for enabling transactions on a digital platform configured to perform selective communication between users, the users being at least one from an ordinary user, a supplier, a premium supplier, an agent, an external agent, a launching agent and an additional agent, the digital platform being composed of at least a plurality of databases that can be selectively accessed by each respective user, the plurality of databases being composed of at least one free advertising database, a premium advertising database, a request database, an client intermediate database, an object intermediate database and a new objects database, wherein the databases can digitally communicate with each other and with users, the users being able to selectively communicate digitally with each other, being compatible with the method.

### BRIEF DESCRIPTION OF THE DRAWINGS

The present invention will now be described in more detail based on one embodiment shown in the drawings. The figures show:

FIG. 1—is an illustration of a plurality of databases;

FIG. 2—is a representation of comparisons between databases according to the teachings of the present invention;

FIG. 3—is a schematic representation of the data flow of the present invention;

FIG. 4—is an example of a sign generated in accordance with the present invention.

### DETAILED DESCRIPTION OF THE FIGURES

In principle, the present invention relates to a method of enabling transactions on a digital platform, wherein said transaction refers, for example, to the purchase and sale of a property or lease/rental or exchange of the same, as described below. However, this feature related to real estate should not be understood as a limitation of the present invention so that other goods can also be related to said transaction.

In other words, the transaction refers to some type of acquisition of goods, whether purchase and sale, rental or others.

In general, the present method is configured to allow the selective communication between its users, which is, for example, in the sense that users sometimes communicate with each other and sometimes they do not. In relation to said users, they are meant to be parties involved in a property transaction (purchase, sale, exchange and/or rental), that is, they are preferably people involved in this type of activity, such as buyers, sellers and realtors, for example.

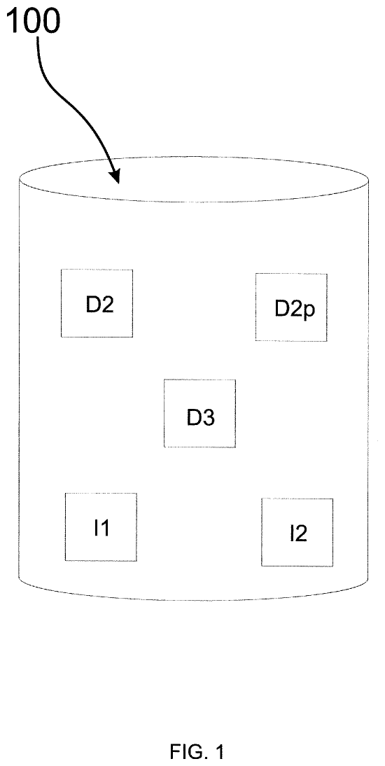

Thus, as shown in FIGS. 1 to 4, users are referred to as at least one ordinary user 10, at least one supplier 20, at least one premium supplier 25, at least one agent 30, at least one external agent 35, at least one launching agent A and at least one additional agent X.

In general, users can be understood as follows: the ordinary user 10 is a person interested in acquiring a property, either by purchase (buyer) or rental (lessee; tenant).

The supplier 20 is the one with free subscription that provides the property to be acquired, either by sale (seller) or rent (landlord; owner).

In turn, the premium supplier 25 is the one who subscribes to a premium plan and provides the property to be acquired, either by sale (seller) or rent (landlord; owner).

The agent 30, in turn, is the one who intermediates the transaction, regardless of the nature of the transaction, that is, he/she is a user such as real estate agent or broker. For a suitable embodiment of the present invention, the agent 30 subscribes to a broker plan, which allows said agent 30 to take advantage of the technical characteristics described herein.

The external agent 35, on the other hand, must be understood as a third party who is “adopted” (sponsored) by an agent 30. Thus, the external agent 35 will be able to perform certain actions on behalf of the agent 30 as will be further detailed below. In any case, the external agent 35 is a third party who may present any occupation or graduation not necessarily related to transaction of goods, but who in any case wishes to act in this field by assisting the agent 30. For example, the external agent 35 is an application driver.

It should be noted that the agent 30 can adopt an external agent 35.

External agents 35 can indicate to the agent 30 potential users that they may use the method of the present invention. In one embodiment, different rewards can be sent to these external users 35 in view of the potential users indicated to the agent 30.

The launching agent A represents a construction company or a managing company who is launching a new property.

In addition, the additional agent X should be understood as a representative of agent 30 who can manage the goods registered by him/her and perform searches only in databases of premium advertisings D2p and new objects D4, but he/she cannot perform searches in free advertising databases D2, order data databases D3, client intermediate databases I1, object intermediate databases I2 (which will be better described below), using an artificial intelligence system (also to be described below) and neither can they turbocharge sales or make offers.

Concerning the digital platform, it is composed of at least a plurality of databases 100 as shown especially in FIG. 1, which can be selectively accessed by each respective user.

It should be noted that the plurality of databases 100 can be comprised by several different databases in addition to those described herein, for example, properties for auction or others, as long as they are in line with the objects of the present invention.

In one embodiment, the plurality of databases 100 is composed of at least one free advertising database D2, one premium advertising database D2p, one request database D3, one client intermediate database I1, one object intermediate database I2 and a new objects database D4, as can be seen in particular in FIG. 1.

All of these databases are set up to store data on the traded properties, such as price, floor area, address, photos, videos and the like. Obviously, other data can be included without changing the application and the objectives of the present invention. In any case, this specification will refer to “data” in the sense of property information.

The free advertising database D2 is configured to store data (set of information) provided by at least one from a supplier 20 and an external agent 35 to be viewed by the agent 30.

Thus, the proposed method comprises a step of receiving data from at least one of the supplier 20 and the external agent 35, storing it in the free advertising database D2 and allowing the agent 30 to view the data stored in this database.

In other words, the free advertising database D2 receives data from the supplier 20 and the external agent 35 and can only be viewed by the agent 30. Such a free advertising database D2 can be understood as a free database.

The present method further comprises a step of receiving data from at least one of the premium supplier 25, the agent 30 and additional agent X, storing it in the premium advertising database D2p and allowing one from the ordinary user 10, the agent 30, the external agent 35 and additional agent X to view the data stored in the database.

This step means that the premium advertising database D2p can receive data and be accessed and viewed by the premium provider 25, the agent 30 and additional agent X, that is, subscribing users. Thus, the premium advertising database D2p can be understood as a paid database.

It should be noted that data from the free advertising database D2 can be configured as data from the premium advertising database D2p, so that at least one data from the free advertising database D2 is transmitted to the data premium advertising database D2p.

Therefore, the present method further comprises the steps of configuring at least one data from the free advertising database D2 as at least one data from the premium advertising database D2p and transmitting at least one data from the free advertising database D2 to the premium advertising database D2p.

These steps can be understood as a turbocharging, in which data from the free advertising database D2 becomes data from the premium advertising database D2p.

The turbocharging steps are performed by at least one of the agent 30 and the external agent 35 or by at least one agent 30 and a supplier 20, wherein the steps are performed by the agent 30 by enabling a turbocharging.

It should be noted that, according to the above, the turbocharging steps performed by the agent 30 take place in such a way that said agent 30 turbocharges the data from the free advertising database D2. In the case of external agent 35, he/she can also perform the turbocharging steps, but with a limited amount of data.

Thus, the proposed method comprises a step of receiving data from the agent 30, storing it in the client intermediate database I1 and allowing the agent 30 to view the data stored in this database.

The client intermediate database I1 can therefore be understood as a database of potential clients, that is, possible real estate buyers.

Similarly, the method of the present invention comprises a step of receiving data from agent 30, storing it in the object intermediate database I2 and allowing the agent 30 to view the data stored in this database.

Thus, the object intermediate database I2 can be understood as a database of potential properties to be transacted.

The proposed method further comprises a step of receiving data from at least one of the ordinary user 10 and the external agent 35, storing it in the request database D3 and allowing the agent 30 to view the data stored in this database.

In other words, the request database D3 can be understood as a database related to a property that was not yet acquired by at least one of these users but that he/she wishes to acquire in the future.

Furthermore, when an agent 30 adopts an external agent 35, the data received from the external agent 35 in the request database D3 must be identified as having been received by the agent 30.

It is a step of the method of the present invention to receive data from the launching agent A, store it in the new objects database D4 and allow at least one from the ordinary user 10, the agent 30, the external agent and the additional agent X to view the data stored in said database.

Thus, the database of new objects D4 can be understood as a database of launches in which properties to be launched by construction companies, contractors and managing companies are registered. Thus, at least one of the common user 10, the agent 30, the external agent 35 and the additional agent X will know when the launching agent A registers new properties for launching, that is, when data is entered in the launching database D4.

Having described the main characteristics of the databases and related steps, the method of the present invention further comprises additional steps.

The method further provides steps of selectively comparing data from at least two databases, enabling a transaction of at least one object if at least one data from each of the compared databases is compatible, wherein the transaction is carried out between users relative to said compatible data.

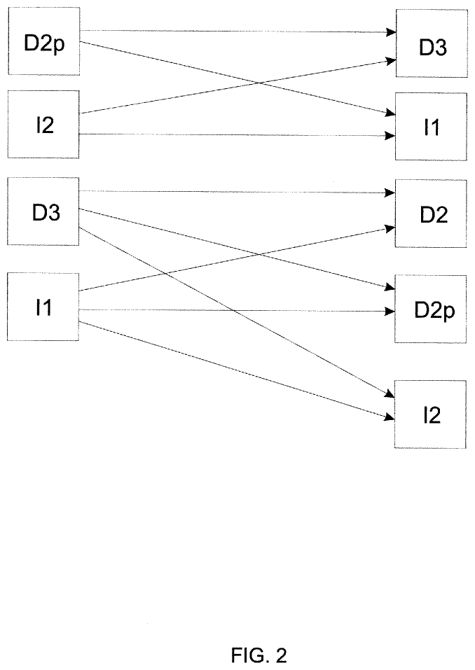

More specifically and with reference to FIG. 2, the step of selectively comparing data from at least two databases is performed as follows:
the premium advertising database D2p is compared with the request database D3 and the client intermediate database I1;
the object intermediate database I2 is compared with the request database D3 and with the client intermediate database I1;
the request database D3 is compared with the free advertising database D2, the premium advertising database D2p and the object intermediate database I2;
the client intermediary database I1 is compared with the free advertising database D2, the premium advertising database D2p and the object intermediate database I2.

In turn, the step of enabling a transaction of at least one object if at least one data from each of the compared databases is compatible is set so that:
at least one data from the premium advertising database D2p can be compatible with at least one data from at least one of the request database D3 and the client intermediate database I1;
at least one data from the object intermediate database I2 can be compatible with at least one of data from at least one of the request database D3 and the client intermediate database I1;
at least one data from the request database D3 can be compatible with at least one data from at least one of the free advertising database D2, the premium advertising database D2p, and the object intermediate database I2;
at least one data from the client intermediate database I1 can be compatible with at least one data from at least one of the free advertising database D2p, the premium advertising database D2p and the object intermediate database I2.

Compatibility between data as described above is designated “match”, that is, for each pair of compatible data, a “match” is generated, and the transaction is enabled for a given property.

Knowing that it is common to place visual indicators such as signs on the goods to be sold, the present method advantageously comprises a step of generating at least one sign 40 based on at least one data provided by the premium supplier 25, the agent 30 and/or additional agent X.

According to the present method, the sign 40 comprises at least one code configured to be scanned by the ordinary user 10 and to provide information on the goods that is the object of the transaction. In one embodiment, the code is a QR code.

This embodiment, however, can alternatively be given as another type of signaling such as a sticker or the like, also provided with a code that can be scanned by a user.

Regarding the code, as discussed, this is preferably a QR code but it can be configured just like any other type of code that can be scanned, accessed or detected by an external device. NFC is an example.

In any case, the proposed method provides that scanning of the code on the sign 40 will provide information on the object of the transaction.

One embodiment of the present method further comprises a step of providing at least one auxiliary information to any user through an artificial intelligence module. By auxiliary information is meant any information required by users of the method, such as searches of specific databases, rules, regulations, legislation, zoning, organizations and institutions, among others.

Obviously, this information should not be understood as limitations of the present invention, so that other auxiliary information can also be provided by the artificial intelligence module.

Moreover, one embodiment of the present method further provides a step of generating at least one transaction validation file based on additional information provided at least by users relative to compatible information of the enabled transaction, as already described.

Such a validation file comprises, in one embodiment, at least one of a contract, regulation, information letter or notice file, but other documents can be alternatively generated.

In accordance with the above and in a manner compatible with the transaction enabling method on a digital platform as now described, the present invention advantageously comprises a system for enabling a transaction on a digital platform.

It should be noted that, with the exception of due adaptations, the features of the method for enabling a transaction on a digital platform as described herein apply to the system for enabling a transaction on a digital platform that is also the object of the present invention.

In this context, said transaction enabling system is configured to carry out selective communication between at least one ordinary user 10, at least one supplier 20, at least one premium supplier 25, at least one agent 30, at least one external agent 35, at least one launching agent A and at least one additional agent X. Preferably, communication is made between at least one ordinary user 10, at least one supplier 20, at least one premium supplier 25 and at least one agent 30.

Such a selective communication is carried out similarly to the communications previously described, that is, different users can contact (communicate) each other in face of different operating conditions of the system.

Also, the digital platform comprises at least a plurality of databases 100, which can be selectively accessed by each respective user. Such a plurality of databases 100 is in turn comprised of at least one free advertising database D2, one premium advertising database D2p, one request database D3, one client intermediate database I1, one object intermediate database I2 and one new objects database D4, which have been described in detail above and which in general digitally communicate with each other and with users of the system.

In relation to the digital platform, it comprises a digital center 1000 that is configured to operate in accordance with the method of the present invention.

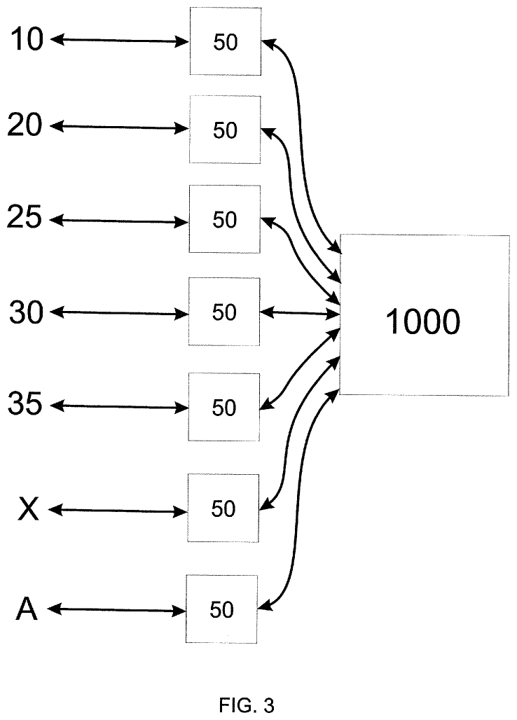

In this sense, as previously described, each user can enter data and view certain databases, which takes place via an external device 50. In one preferential embodiment, there is an external device for each user, as shown in FIG. 3.

Such an external device 50 is preferably configured as a smartphone, but may alternatively be a tablet, a generic cell phone or any other device capable of operating in accordance with the teachings of the method and system of the present invention.

In general, the system of the present invention is configured to selectively compare data from at least two databases, enabling a transaction of at least one object if at least one data from each of the compared databases is compatible, wherein the transaction is carried out between users relative to compatible data.

To this end, the system is configured so that:
at least one data from the premium advertising database D2p can be compatible with at least one data from at least one of the request database D3 and the client intermediate database I1;
at least one data from the object intermediate database I2 can be compatible with at least one of data from at least one of the request database D3 and the client intermediate database I1;
at least one data of the request database D3 can be compatible with at least one data from at least one of the free advertising database D2, the premium advertising database D2p, and the object intermediate database I2;
at least one data from the client intermediate database I1 can be compatible with at least one data from at least one of the free advertising database D2, the premium advertising database D2p and the object intermediate database I2.

One embodiment of the system that is object of the present invention further provides that the data from the free advertising database D2 can be configured as data from the premium advertising database D2p. Thus, at least one data from the free advertising database D2 is transmitted to the premium advertising database D2p.

This feature can be understood as a turbocharging, in which data from the free advertising database D2 becomes data from the premium advertising database D2p.

The turbocharging is performed by at least one of the agent 30 and the external agent 35 or by at least one agent 30 and a supplier 20, wherein it is performed by the agent 30 by enabling a turbocharging.

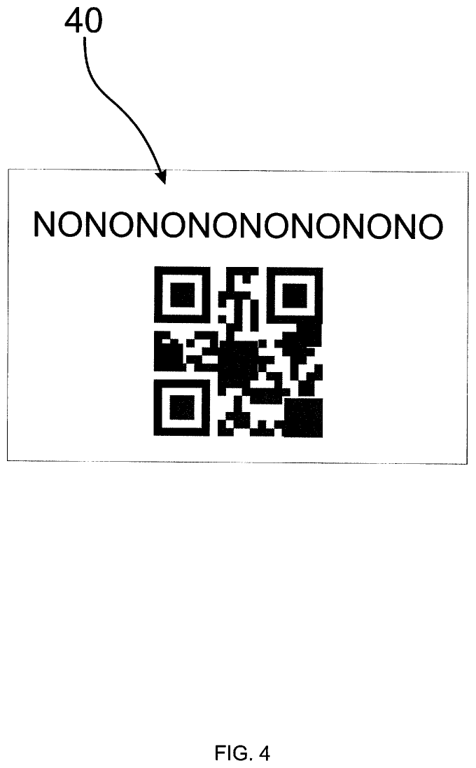

The system is further configured to generate at least one sign 40 based on at least one data from the premium advertising database D2p, as shown in FIG. 4.

As already described and can be seen from this figure, the generated sign 40 comprises at least one code that can be scanned to provide information on the object of the transaction, that is, information on the property.

Moreover, the present system is provided with an artificial intelligence module configured to provide at least one auxiliary information to any user. As already described, by auxiliary information is meant any information required by users of the method, such as searches of specific databases, rules, regulations, legislation, zoning, organizations and institutions, among others.

Obviously, this information should not be understood as limitations of the present invention, so that other auxiliary information can also be provided by the artificial intelligence module.

The system of the present invention is further configured so that it can generate at least one transaction validation file based on additional information provided at least by users relative to compatible information of the enabled transaction. In other words, real estate sale, purchase and rental contracts can be generated.

Additional information may include personal data from the users involved, additional data on the property, etc. so that the transaction is properly documented and carried out.

Finally, the present invention further comprises a real estate transaction platform that is an application compatible with the method and system already described.

In order to facilitate the understanding of the technical functional characteristics of the method and system of enabling a transaction on a goods transaction platform of the present invention, practical examples will be given below, where the goods of the transaction is a real estate property.

### Example 1—Transaction

The supplier 20 wishes to sell his property of 50 m2 built area, located in Neighborhood A of city B for the value of 500,000 monetary units.

In this case, the property data provided by the supplier 20 to the free advertising database D2 are:
Location: Neighborhood A, City B
50 m2 built area
Price: 500,000 monetary units

In turn, one agent 30 knows of a potential client who is looking for a property located in Neighborhood A of city B, of 50 m2 and a maximum value of 750,000 monetary units and registers this property in the client intermediate database I1.

In this case, after the databases are compared there will be a match because data is compatible.

Such a compatibility enables a transaction of the property, that is, agent 30 can contact supplier 20, negotiate and eventually close the transaction now enabled by the present invention.

### Example 2—Role of the External Agent

External agent 35 is, for example, an application driver who gets in contact with a plurality of people. In this context, he/she becomes aware that a third party wishes to acquire a property.

The desired property has 50 m2 built area, is located in Neighborhood A of city B and the offered value is 500,000 monetary units.

In this case, the external agent 35 sponsored by an agent 30 advertises this property in the request database D3, so that agent 30 will search for an offered property that meets these needs.

A property having the required characteristics is registered in the premium advertising database D2p, so that there is a match, enabling the transaction.

If the transaction now enabled by the present invention is closed, the external agent 35 can receive a bonus, such as a percentage on the sale price, a fixed commission, among others.

Thus, advantageously, the present invention proposes a method and a system for enabling transactions on a goods transaction platform.

The method and system for enabling transactions on a goods transaction platform may be compatible with a communication network, a dynamic database and an Internet/Web interface, the database being such as a Hard Disk Drive (HDD), a CD drive, memory cards, non-volatile storage chip (Electrically-Erasable Programmable Read-Only Memory—EEPROM), Flash memory, or any other memory device capable of receiving, transmitting and storing data. It may also comprise processing circuits for processing the data stored.

The communication network may be connected to one or more external wireless or wired networks, such as a Personal Area Network (PAN), a Local Area Network (LAN), a Metropolitan Area Network (MAN), a Wide-Area Network (WAN), a Wireless Local Area Network (WLAN), among others.

An user of the present invention may be connected to a mobile or fixed terminal, such as a personal computer, a tablet, a cellular apparatus or any other responsible for the electronic coordination of the performance of steps and features of the invention through the communication network. The steps and features may, for instance, be performed by means of a dedicated application.

The invention may also be autonomous and automatic, being, by means of processors, controllers, memories or any other electronic component capable of coordinating, by means of artificial intelligence, the performance of steps and features of the present invention through the communication network.

Last and in view of the above, the invention also comprises a memory device capable of receiving, transmitting and storing data, being configured to perform the steps of the method and a system for enabling transactions on a goods transaction platform.

Having described a preferred embodiment of the present invention, as well as a plurality of examples and practical applications thereof, it should be understood that the scope of the present invention encompasses other possible variations, being limited only by the content of the appended claims, including any possible equivalents thereof.

1. A method of enabling a transaction on a digital platform configured to allow selective communication between at least one ordinary user (10), at least one supplier (20), at least one premium supplier (25), at least one agent (30), at least one external agent (35), at least one launching agent (A) and at least one additional agent (X), the digital platform comprising at least a plurality of databases (100) that may be selectively accessed by each respective user, the plurality of databases (100) comprising at least one free advertising database (D2), a premium advertising database (D2p), a request database (D3), an client intermediate database (I1), an object intermediate database (I2) and a new objects database (D4), the method comprising the steps of:
receiving data from at least one of the supplier (20) and the external agent (35), storing it in the free advertising database (D2) and allowing the agent (30) to view the data stored in this database;
receiving data from at least one of the premium supplier (25), the agent (30) and additional agent (X), storing it in the premium advertising database (D2p) and allowing one from the ordinary user (10), the agent (30), the external agent (35) and additional agent (X) to view the data stored in the database;
receiving data from the agent (30), storing it in the client intermediate database (I1) and allowing the agent (30) to view the data stored in this database;
receiving data from agent (30), storing it in the object intermediate database (I2) and allowing the agent (30) to view the data stored in this database;
receiving data from at least one of an ordinary user (10) and the external agent (35), storing it in the request database (D3) and allowing the agent (30) to view the data stored in this database;
receiving data from the launching agent (A), storing it in the new objects database (D4) and allowing at least one from the ordinary user (10), the agent (30), the external agent (35) and the additional agent (X) to view the data stored in said database;
selectively comparing data from at least two databases;
enabling a transaction of at least one object if at least one data from each of the compared databases is compatible, wherein the transaction is carried out between users relative to compatible data.

2. The method of enabling a transaction of claim 1, wherein the step of enabling a transaction of at least one object if at least one data from each of the compared databases is compatible is set so that:
at least one data from the premium advertising database (D2p) may be compatible with at least one data from at least one of the request database (D3) and the client intermediate database (I1);
least one data from the object intermediate database (I2) may be compatible with at least one of data from at least one of the request database (D3) and the client intermediate database (I1);
at least one data from the request database (D3) may be compatible with at least one data from at least one of the free advertising database (D2), the premium advertising database (D2p), and the object intermediate database (I2);
at least one data from the client intermediate database (I1) may be compatible with at least one data from at least one of the free advertising database (D2), the premium advertising database (D2p) and the object intermediate database (I2).

3. The method of enabling a transaction of claim 2, wherein data from the free advertising database (D2) may be configured as data from the premium advertising database (D2p), so that at least one data from the free advertising database (D2) is transmitted to the premium advertising database (D2p), wherein the method further comprises the steps of configuring at least one data from the free advertising database (D2) as at least one data from the premium advertising database (D2p) and transmitting at least one data from the free advertising database (D2) to the premium advertising database (D2p).

4. The method of enabling a transaction of claim 3, wherein the steps of configuring at least one data from the free advertising database (D2) as at least one data from the premium advertising database (D2p) and transmitting at least one data from the free advertising database (D2) to the premium advertising database (D2p) are performed by at least one of the agent (30) and the external agent (35) or by at least one agent (30) and one supplier (20), wherein the steps are performed by the agent (30) by enabling a turbocharging.

5. The method of enabling a transaction of claim 4, wherein the additional agent (X) may access the premium advertising database (D2p) and the new objects database (D4).

6. The method of enabling a transaction of claim 5, further comprising a step of generating at least one sign (40) based on at least one data from the premium advertising database (D2p).

7. The method of enabling a transaction of claim 6, wherein the sign (40) comprises at least one code that may be scanned and provide information on the object of the transaction.

8. The method of enabling a transaction of claim 7, further comprising a step in which the agent (30) adopts an external agent (35), so that the data received from the external agent (35) in the request database (D3) are identified as having been received by the agent (30).

9. The method of enabling a transaction of claim 8, further comprising a step of providing at least one auxiliary information to any user by means of an artificial intelligence module.

10. The method of enabling a transaction of claim 9, further comprising a step of generating at least one transaction validation file based on information provided at least by users relative to compatible information concerning the enabled transaction.

11. The method of enabling a transaction of claim 10, wherein the method is configured to allow the transaction of at least one real estate property.

12. A system of enabling a transaction on a digital platform configured to allow selective communication between users, the users being at least one from an ordinary user (10), a supplier (20), a premium supplier (25), an agent (30), an external agent (35), a launching agent (A) and an additional agent (X), the digital platform comprising at least a plurality of databases (100) that may be selectively accessed by each respective user, the plurality of databases (100) comprising at least one free advertising database (D2), a premium advertising database (D2p), a request database (D3), an client intermediate database (I1), an object intermediate database (I2) and a new objects database (D4), the databases being able to digitally communicate with each other and with users (10, 20, 25, 30, 35, A, X), wherein the users (10, 20, 25, 30, 35, A, X) may selectively communicate with each other, wherein the platform comprises a digital center (1000) configured so that:
by means of an external device (50), at least one of the supplier (20) and the external agent (35) may send data to the free advertising database (D2) and the agent (30) may view the free advertising database (D2);
by means of an external device (50) at least one of the premium supplier (25), the agent (30) and the additional agent (X) may send data to the premium advertising database (D2p) and at least one of the ordinary user (10), the agent (30), the external agent (35) and the additional agent (X) may view the premium advertising database (D2p);
by means of an external device (50), the agent (30) may send data to the client intermediate database (I1) and view such database (I1);
by means of an external device (50), the agent (30) may send data to the object intermediate database (I2) and view this database (I1);
by means of an external device (50), at least one of the ordinary user (10) and the external agent (35) may send data to the request database (D3) and the agent (30) may view the request database (D3);
by means of an external device (50) the launching agent (A) may send data to the new objects database (D4) and at least one of the ordinary user (10), the agent (30), and the external agent (35) may view the request database (D3);
wherein the system is configured to selectively compare data from at least two databases, enabling a transaction of at least one object if at least one data from each of the compared databases is compatible, wherein the transaction is carried out between users relative to compatible data.

13. The system of enabling a transaction of claim 12, wherein the system is configured so that:
at least one data from the premium advertising database (D2p) may be compatible with at least one data from at least one of the request database (D3) and the client intermediate database (I1);
at least one data from the object intermediate database (I2) may be compatible with at least one of data from at least one of the request database (D3) and the client intermediate database (I1);
at least one data from the request database (D3) may be compatible with at least one data from at least one of the free advertising database (D2), the premium advertising database (D2p), and the object intermediate database (I2);
at least one data from the client intermediate database (I1) may be compatible with at least one data from at least one of the free advertising database (D2), the premium advertising database (D2p) and the object intermediate database (I2).

14. The system of enabling a transaction of claim 13, wherein data from the free advertising database (D2) may be configured as data from the premium advertising database (D2p), so that at least one data from the free advertising database (D2) is transmitted to the free advertising database (D2).

15. The system of enabling a transaction of claim 14, wherein the agent (30) and the external agent (35) may configure at least one data from the free advertising database (D2) as at least one data from the premium advertising database (D2p) and transmit at least one data from the free advertising database (D2) to the premium advertising database (D2p), wherein the agent (30) requires a turbocharging to ne enabled to this end.

16. The system of enabling a transaction of claim 15, wherein the additional agent (X) may access the premium advertising database (D2p) and the new objects database (D4).

17. The system of enabling a transaction of claim 16, wherein the system is further configured to generate at least one sign (40) based on at least one data from the premium advertising database (D2p).

18. The system of enabling a transaction of claim 17, wherein the sign (40) comprises at least one code that may be scanned and provide information on the object of the transaction.

19. The system of enabling a transaction of claim 18, wherein the agent (30) may adopt an external agent (35), so that the data received from the external agent (35) in the request database (D3) is identified as having been received by the agent (30).

20. The system of enabling a transaction of claim 19, wherein the system is provided with an artificial intelligence module configured to provide at least one auxiliary information to any user.

21. The system of enabling a transaction of claim 20, wherein the system may generate at least one transaction validation file based on information provided at least by users relative to compatible information concerning the enabled transaction.

22. The system of enabling a transaction of claim 21, wherein the system is configured to allow the transaction of at least one real estate property.

23. (canceled)

24. (canceled)

25. (canceled)

26. (canceled)

27. (canceled)

28. (canceled)
